(19) United States
(12) Patent Application Publication
(10) Pub. No.: US 2008/0285551 A1
(43) Pub. Date: Nov. 20, 2008

(54) Method, Apparatus, and Computer Program Product for Implementing Bandwidth Capping at Logical Port Level for Shared Ethernet Port

(76) Inventors: Shamsundar Ashok, Austin, TX (US); Shawn Michael Lambeth, Pine Island, MN (US); Bryan Mark Logan, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/750,420

(22) Filed: May 18, 2007

(51) Int. Cl. H04L 12/56

(52) U.S. Cl. 370/389

(57) ABSTRACT

Bandwidth capping is implemented at a logical port level for a shared Ethernet port. When a physical port of a Host Ethernet Adapter (HEA) is partitioned, a Logical HEA is created for the partition. One or a plurality of Logical Ports (LPorts) is created in the Logical HEA. Each LPort is mapped to a corresponding physical port. During LPAR configuration, a minimum guaranteed speed is specified for the LPort together with the corresponding physical port for the LPort and an optional maximum speed. The specified configuration for the LPort is verified, and the configuration values are stored in the HEA and the HEA dispatches data packets based upon the stored configuration values for the LPort.

### FIELD OF THE INVENTION

The present invention relates generally to the data processing field, and more particularly, relates to a method, apparatus and computer program product for implementing bandwidth capping at a logical port level for a shared Ethernet port.

### DESCRIPTION OF THE RELATED ART

A single Ethernet port, for example, having a capacity of 1 Gbps or 10 Gbps, can be partitioned across multiple systems. For example, a single RJ-45 port could support up to 16 partitions.

Known arrangements for network virtualization typically use a shared Ethernet adapter managed by the host operating system (OS) and uses virtual network bridging.

A disadvantage of the conventional Ethernet adapter sharing arrangements is that a data packet path is provided through the hypervisor. Also packet forwarding is dependent upon an input/output (I/O) hosting partition.

A need exists for an effective mechanism for implementing bandwidth capping for a shared Ethernet port. It is desirable to provide such mechanism for implementing both a minimum guaranteed speed and a maximum speed for a logical port of the shared Ethernet port.

### SUMMARY OF THE INVENTION

A principal aspect of the present invention is to provide a method, apparatus and computer program product for implementing bandwidth capping at a logical port level for a shared Ethernet port. Other important aspects of the present invention are to provide such a method, apparatus and computer program product for implementing bandwidth capping substantially without negative effect and that overcome many of the disadvantages of prior art arrangements.

In brief, a method, apparatus and computer program product are provided for implementing bandwidth capping at a logical port level for a shared Ethernet port. When a physical port of a Host Ethernet Adapter (HEA) is partitioned, a Logical HEA is created for the partition. One or a plurality of Logical Ports (LPorts) is created in the Logical HEA. Each LPort is mapped to a corresponding physical port. A configuration is specified for the LPort with a minimum guaranteed speed being specified for the LPort during LPAR configuration together with the corresponding physical port for the LPort, and an optional maximum speed value for the LPort.

In accordance with features of the invention, the specified minimum guaranteed speed for the LPort is summed with a minimum value for all LPorts connected to the corresponding physical port to provide a total speed. The resulting total speed is compared with a capacity of the physical port to verify that the specified configuration does not exceed the capacity of the physical port. When the total speed does not exceed the capacity of the physical port, the configuration values for the logical port are stored in the HEA for that logical port and the HEA dispatches data packets based upon the stored configuration values.

In accordance with features of the invention, the configuration values for the logical port are loaded into the HEA hardware configuration registers for that logical port. During dispatching of data packets, the HEA optionally keeps track of bandwidth used in statistic registers on a per LPort basis while servicing logical ports. The statistic registers along with the configuration registers are used to determine which LPort sends data next.

In accordance with features of the invention, the configuration values for the logical port optionally include a maximum speed value being specified for the LPort. The specified maximum speed value is used during dispatching of data packets to limit performance for the LPort. For example, data packets are transferred from Lports set to ready during dispatching of data packets. When a timeslice is completed for an LPort, the LPort is set to not ready, an LPort bandwidth delay timer is set. The LPort is set to ready when the LPort bandwidth delay timer completes and then can be selected during dispatching of data packets.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is block diagram representation illustrating an exemplary logical partition computer system including a Host Ethernet Adapter for implementing bandwidth capping methods in accordance with the preferred embodiment;

FIGS. 2, 3, and 4, are flow charts illustrating exemplary steps for implementing bandwidth capping at a logical port level for a shared Ethernet port in accordance with the preferred embodiment; and

FIG. 5 is a block diagram illustrating a computer program product in accordance with the preferred embodiment.

### DETAILED DESCRIPTION OF THE PREFERRED EMBODIMENTS

In accordance with features of the invention, a Host Ethernet Adapter (HEA) is provided. The HEA includes a plurality of physical ports, such as, four RJ-45 ports that can be partitioned across multiple systems. A single RJ-45 port can support, for example, up to 16 partitions using the single port, without the partitions able to see each others traffic. These ports are, for example, either 1 Gbps or 10 Gbps. This capacity is divided among the partitions using that physical port.

In accordance with features of the invention, with the HEA, the hardware of the HEA is doing the virtualization, eliminating the need for conventional network virtualization. Conventional network virtualization is done by using a shared Ethernet adapter managed by the host operating system (OS) and virtual network bridging.

In accordance with features of the invention, when the logical port of the HEA is configured a minimum guaranteed speed is specified, together with the option of specifying a maximum speed. A system operator is allowed to configure the logical port and specify a minimum guaranteed speed during LPAR configuration, along with the option of specifying the maximum speed. When the configuration is sent down, the hypervisor validates the configuration to make sure that the minimum bandwidth can be provided. These configuration values are then passed on to the hardware and stored, which performs the appropriate dispatching.

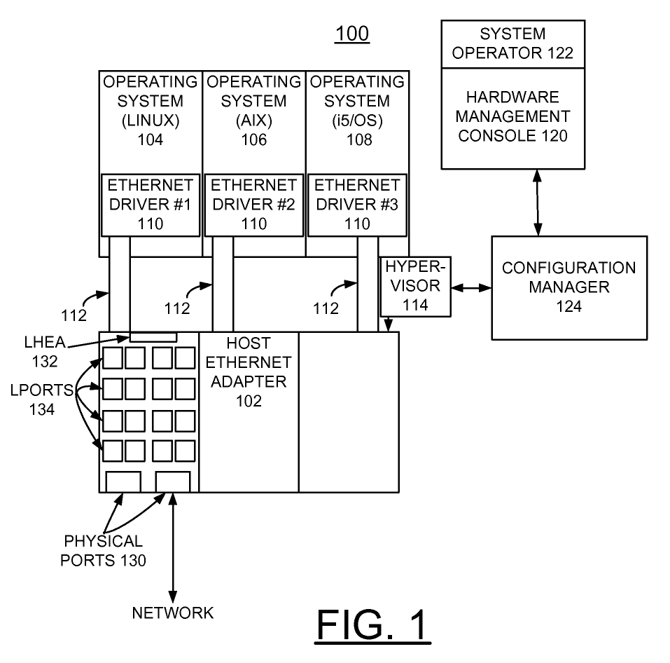

Having reference now to the drawings, in FIG. 1, there is shown an exemplary computer system generally designated by the reference character 100 including a Host Ethernet Adapter (HEA) 102 for implementing bandwidth capping methods in accordance with the preferred embodiment. Computer system 100 is a logical partition (LPAR) system including a plurality of operating systems 104, 106, 108, such as, for example, Linux 104, AIX 106, and i5/OS 108, where AIX and i5/OS are trademarks of International Business Machines Corporation of Armonk, N.Y.

Computer system 100 includes a respective Ethernet driver #1-3, 110 coupled to the respective operating systems 104, 106, 108 and that is respectively connected to the HEA 102 as indicated by a respective directly connected data path 112. Conventional Ethernet sharing arrangements include a path through the hypervisor, and is dependent on an I/O hosting partition for forwarding a data packet.

In accordance with features of the invention, with each of the Ethernet drivers #1-3, 110 respectively connected to the HEA 102 by a respective directly connected data path 112, there are no hypervisor hits, and data packet transfer is not dependent upon and does not require any other LPAR to be running.

In accordance with features of the invention, when a physical port 130 of the HEA 102 is partitioned, a Logical HEA (LHEA) 132 is created for the partition. Each partition includes an LHEA 132. A plurality of LPorts 134 is created in each LHEA 132. The LPorts 134 are mapped to a corresponding physical port 130. One physical port 130 typically is mapped by multiple logical ports 134, for example, 16 LPorts 134. Bandwidth cannot be effectively limited at the physical port level, but is rather specified at the Logical Port level in accordance with the preferred embodiment.

Computer system 100 includes a system resources manager or hypervisor 114 that allocates resources among the operating systems 104, 106, 108. Computer system 100 includes a hardware management console 120 receiving system operator inputs as indicated at a block system operator 122 in accordance with the preferred embodiment. The hardware management console 120 is coupled to a configuration manager 124, receiving configuration requests from the hardware management console 120 in accordance with the preferred embodiment. The configuration manager 124 is coupled to the hypervisor 114 for processing configuration requests from the hardware management console 120 in accordance with the preferred embodiment.

Computer system 100 is shown in simplified form sufficient for understanding the present invention. The illustrated computer system 100 is not intended to imply architectural or functional limitations. The present invention can be used with various hardware implementations and systems and various other internal hardware devices.

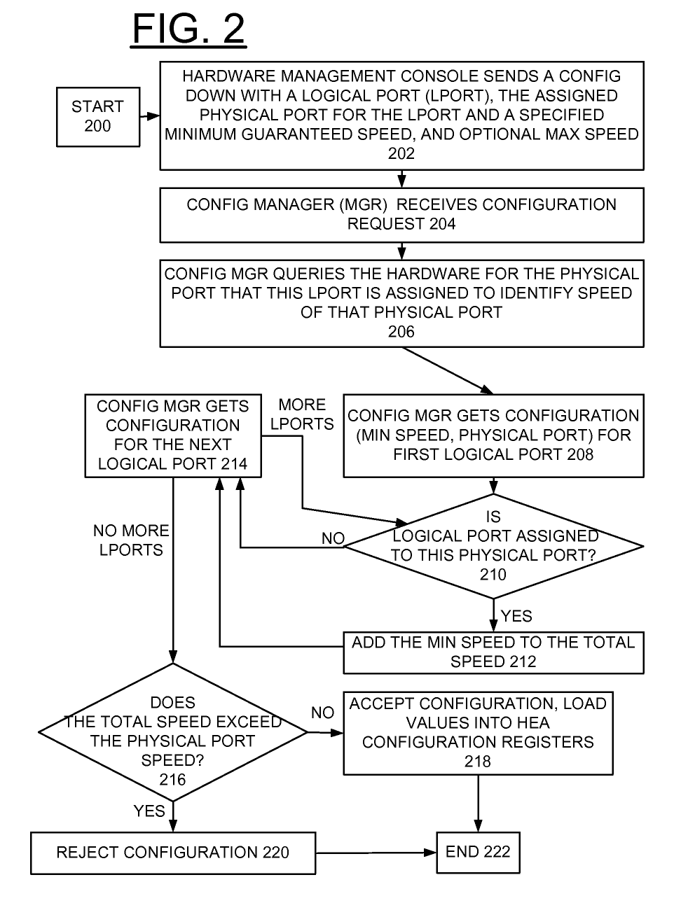

Referring to FIGS. 2, 3, and 4, there are shown exemplary steps for implementing bandwidth capping at a logical port level for a shared Ethernet port in accordance with the preferred embodiment.

In accordance with features of the invention, when an operator configures a logical port 134 on an HEA 102, a display is presented to ask the system operator for a minimum and a maximum bandwidth. When the configuration request is sent down to the hypervisor 114, the minimum value for all logical ports 134 connected to that physical port 130 are added together to verify that the total does not exceed the capacity of the physical port. Once this is done, the values for the logical port are loaded into the HEA hardware registers for that logical port.

Referring now to FIG. 2, exemplary steps for implementing bandwidth capping at a logical port level for a shared Ethernet port or physical port 130 start at a block 200. The hardware management console 120 sends a configuration to the configuration manager 124 with a logical port 134, identifying a corresponding physical port 130 for the logical port 134, and a minimum guaranteed speed for the logical port, together with an optional maximum speed specification, as indicated at a block 202.

For example, the configuration sent at block 202 can include a Minimum speed of 1 Gbps, a Maximum speed of 1 Gbps to allow the user to have the equivalent of a 1 Gbps card that is capped at 1 Gbps, and a resulting advantage is that if the physical port is a 10 Gbps port, the customer is restricted to 1 Gbps per partition. The same physical port 130 can be used by other partitions without affecting throughput of this partition.

As indicated at a block 204, the configuration manager 124 receives the configuration request. The configuration manager 124 queries the hardware for the physical port 130 that this logical port 134 is assigned, to identify the speed of that physical port 130 as indicated at a block 206. When the first logical port is added, and the LPAR does not have a LHEA 132 for this HEA 102 then a resource capability for the LHEA to be created is specified.

The configuration manager 124 gets configuration including minimum speed, physical port, for the first logical port as indicated at a block 208. Checking whether a logical port is assigned to this physical port is performed as indicated at a decision block 210. If yes, then the minimum speed of the physical port is added to the total speed as indicated at a block 212. If the logical port is not assigned to this physical port or after the speed is added to the total speed, the configuration manager 124 gets configuration including minimum speed, physical port, for the next logical port as indicated at a block 214. If there are more logical ports, then checking whether the next logical port is assigned to this physical port is performed at decision block 210. If yes, then the speed of the next physical port is added to the total speed at block 212., and then the configuration for the next logical port is identified at block 214.

When there are no more logical ports, then checking whether the total speed exceeds the physical port speed is performed as indicated at a decision block 216. When the configuration manager 124 or hypervisor 114 validates the configuration, determining that the minimum bandwidth can be provided at decision block 216, then the configuration is accepted as indicated at a block 218 and the configuration values are then passed to and stored in HEA hardware for that logical port.

For example, the configuration values are passed to and loaded into hardware configuration registers of HEA 102 for that logical port as shown at block 218. It should be understood that the present invention is not limited to the use of configuration registers for storing configuration values. Another option is, for example, to use Asset Protection keys, check for an activation code, and if one is not present, limit the speed of the logical port to a set value. Asset Protection keys are currently used to restrict the usage of components, such as, shared processors, number of processors, type of OS, and the like, of LPAR systems.

Otherwise, when the total speed exceeds the physical port speed, the configuration is rejected as indicated at a block 220, and the sequential steps end as indicated at a block 222.

In accordance with features of the invention, while the HEA 102 is servicing logical ports, the HEA 102 keeps track of bandwidth used in HEA statistic registers on a per logical port basis. These HEA statistic registers along with the configuration registers, advantageously are used in determine which logical port sends data next. When incoming packets are received, the destination logical port for the incoming packets is determined and the bandwidth usage is added to the statistics registers. When a maximum bandwidth configuration of the logical port does not equal or exceed the physical capability of the physical port, then the physical port may be idle for periods of time.

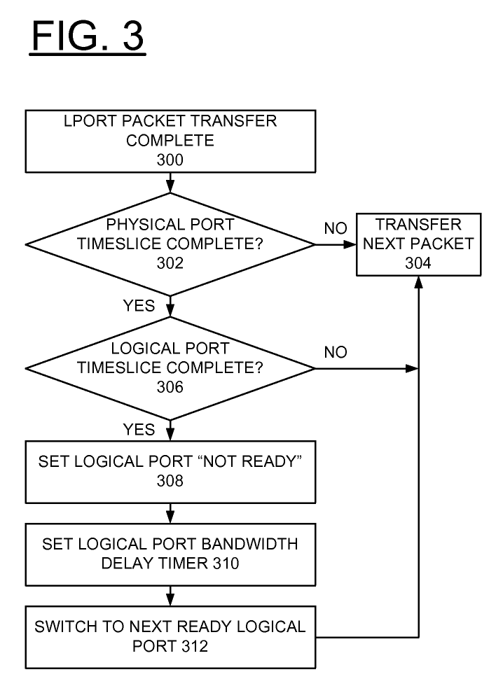

Referring now to FIG. 3, exemplary steps for dispatching data packets and implementing bandwidth capping start at a block 300 with an LPort packet transfer being completed. Checking for a physical port timeslice being completed as indicated at a decision block 302. When the physical port timeslice is not completed, then a next packet is transferred as indicated at a block 304.

It should be understood that various different task and thread dispatching algorithms could be used for transferring packets in accordance with the preferred embodiment.

When the physical port timeslice is completed, then checking for a logical port timeslice being completed as indicated at a decision block 306. When the logical port timeslice is not completed, then a next packet is transferred at block 304. Otherwise when the logical port timeslice is completed, then the logical port is set to “not ready” as indicated at a block 308. Next the logical port bandwidth delay time is set as indicated at a block 310. Switching to a next ready logical port is provided as indicated at a block 312. Then a next packet is transferred at block 304, returning to block 300 when the LPort packet transfer is completed.

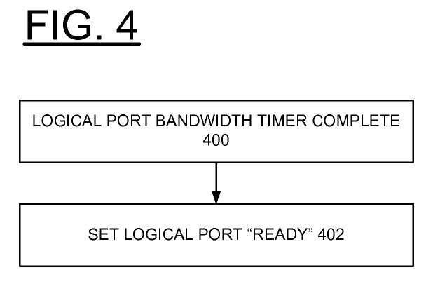

Referring now to FIG. 4, a logical port bandwidth timer completes as indicated at a block 400. Then the logical port is set to “ready” as indicated at a block 402.

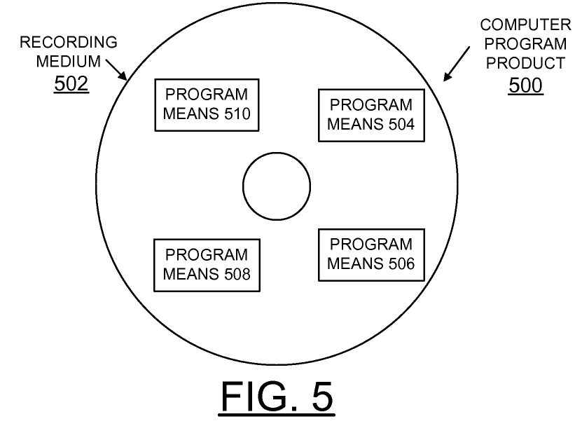

Referring now to FIG. 5, an article of manufacture or a computer program product 500 of the invention is illustrated. The computer program product 500 includes a computer recording medium 502, such as, a floppy disk, a high capacity read only memory in the form of an optically read compact disk or CD-ROM, a tape, or another similar computer program product. Recording medium 502 stores program means 504, 506, 508, 510 on the medium 502 for carrying out the methods for implementing bandwidth capping of the preferred embodiment in the system 100 of FIG. 1.

A sequence of program instructions or a logical assembly of one or more interrelated modules defined by the recorded program means 504, 506, 508, 510, direct the system 100 for implementing bandwidth capping of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing bandwidth capping at a logical port level for a shared Ethernet port comprising the steps of:
partitioning a physical port of a Host Ethernet Adapter (HEA);
mapping a logical port (LPort) to a corresponding physical port;
specifying a configuration for the logical port including a specified minimum guaranteed speed for the logical port together with the corresponding physical port for the logical port during logical partition (LPAR) configuration;
verifying the specified configuration for the logical port and storing said specified minimum guaranteed speed for the logical port together with the corresponding physical port for the LPort in said HEA; and
said HEA, dispatching data packets based upon the stored configuration values.

2. The method for implementing bandwidth capping at a logical port level for a shared Ethernet port as recited in claim 1 wherein partitioning a physical port of a Host Ethernet Adapter (HEA) includes the steps of creating a Logical HEA for the partition; and creating a plurality of said Logical Ports (LPorts) in the Logical HEA.

3. The method for implementing bandwidth capping at a logical port level for a shared Ethernet port as recited in claim 2 wherein verifying the specified configuration for the logical port includes summing the specified minimum guaranteed speed for the logical port with a minimum value for each of said plurality of logical port mapped to the corresponding physical port to provide a total speed.

4. The method for implementing bandwidth capping at a logical port level for a shared Ethernet port as recited in claim 3 further includes comparing said total speed with a capacity of the corresponding physical port to verify that the specified configuration does not exceed the capacity of the corresponding physical port.

5. The method for implementing bandwidth capping at a logical port level for a shared Ethernet port as recited in claim 4 further includes accepting the specified configuration when said total speed does not exceed the capacity of the physical port, and storing the configuration values for the logical port in the HEA.

6. The method for implementing bandwidth capping at a logical port level for a shared Ethernet port as recited in claim 1 wherein storing said specified minimum guaranteed speed for the logical port together with the corresponding physical port for the LPort in said HEA includes loading the configuration values for the logical port into HEA hardware configuration registers for the logical port.

7. The method for implementing bandwidth capping at a logical port level for a shared Ethernet port as recited in claim 6 wherein said HEA, dispatching data packets based upon the stored configuration values further includes said HEA stores bandwidth used values in HEA hardware statistic registers for each logical port while servicing logical ports.

8. The method for implementing bandwidth capping at a logical port level for a shared Ethernet port as recited in claim 6 further includes said HEA using said values stored in said HEA hardware configuration registers and said HEA hardware statistic registers to determine which logical port sends data next.

9. The method for implementing bandwidth capping at a logical port level for a shared Ethernet port as recited in claim 1 wherein specifying a configuration for the logical port further includes specifying a maximum speed value for the logical port.

10. The method for implementing bandwidth capping at a logical port level for a shared Ethernet port as recited in claim 9 wherein dispatching of data packets includes using said specified maximum speed value during dispatching of data packets to limit performance for the logical port.

11. The method for implementing bandwidth capping at a logical port level for a shared Ethernet port as recited in claim 10 wherein dispatching of data packets using said specified maximum speed value includes transferring data packets from the logical ports set to ready.

12. The method for implementing bandwidth capping at a logical port level for a shared Ethernet port as recited in claim 11 further includes setting the logical port to not ready when a timeslice is completed for the logical port and setting a LPort bandwidth delay timer.

13. The method for implementing bandwidth capping at a logical port level for a shared Ethernet port as recited in claim 11 further includes setting the logical port to ready when the LPort bandwidth delay timer completes, whereby the logical port can be selected during dispatching of data packets.

14. An apparatus for implementing bandwidth capping at a logical port level for a shared Ethernet port comprising:
a Host Ethernet Adapter (HEA) including a plurality of physical ports, each physical port being partitioned; a Logical HEA provided for the partition; and a plurality of logical ports provided in the Logical HEA; each said logical port being mapped to a corresponding physical port;
a configuration manager receiving a configuration for a first logical port including a specified minimum guaranteed speed for the logical port together with the corresponding physical port for the logical port during logical partition (LPAR) configuration;
said configuration manager verifying the specified configuration for the logical port and storing said specified minimum guaranteed speed for the logical port together with the corresponding physical port for the LPort in said HEA; and
said HEA, dispatching data packets based upon the stored configuration values.

15. The apparatus for implementing bandwidth capping at a logical port level for a shared Ethernet port as recited in claim 14 wherein said received configuration for a first logical port includes a maximum speed value for the logical port.

16. The apparatus for implementing bandwidth capping at a logical port level for a shared Ethernet port as recited in claim 15 wherein said HEA includes a logical port bandwidth delay timer; and said HEA uses said specified maximum speed value to set said logical port bandwidth delay timer during dispatching of data packets to limit performance for the logical port.

17. A computer recording medium storing a computer program product for implementing bandwidth capping at a logical port level for a shared Ethernet port in a computer system including a Host Ethernet Adapter (HEA), said computer program product including instructions executed by the computer system to cause the computer system to perform the steps comprising:
partitioning a physical port of the Host Ethernet Adapter (HEA);
mapping a logical port (LPort) to a corresponding physical port;
specifying a configuration for the logical port including a specified minimum guaranteed speed for the logical port together with the corresponding physical port for the logical port during logical partition (LPAR) configuration;
verifying the specified configuration for the logical port and storing said specified minimum guaranteed speed for the logical port together with the corresponding physical port for the LPort in said HEA; and
dispatching data packets based upon the stored configuration values with said HEA.

18. The computer recording medium as recited in claim 17 wherein dispatching data packets based upon the stored configuration values with said HEA further includes said HEA storing bandwidth used values in HEA hardware statistic registers for each logical port while servicing logical ports.

19. The computer recording medium as recited in claim 18 further includes said HEA using said values stored in said HEA hardware configuration registers and said HEA hardware statistic registers to determine which logical port sends data next.

20. The computer recording medium as recited in claim 17 wherein specifying a configuration for the logical port further includes a specified maximum speed value for the logical port; and wherein dispatching data packets further includes using said specified maximum speed value to limit performance for the logical port.
